(19) United States
(12) Patent Application Publication
(10) Pub. No.: US 2008/0005532 A1
(43) Pub. Date: Jan. 3, 2008

(54) RANDOM NUMBER GENERATOR AND RANDOM NUMBER GENERATING METHOD

(76) Inventors: Wu-Jie Liao, Changhua County (TW); Meng-Yun Ying, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/671,467

(22) Filed: Feb. 6, 2007

(30) Foreign Application Priority Data
Jun. 30, 2006 (TW) 095123791

(51) Int. Cl. G06F 12/00; G06F 12/06

(52) U.S. Cl. 711/217; 711/5

(57) ABSTRACT

A random number generator, for generating random numbers, includes: a first processing module for generating at least one candidate number array comprising a plurality of candidate numbers respectively corresponding to a plurality of candidate addresses; an address generating module for generating at least one specific address according to at least one generator polynomial, where each specific address is a candidate address within the plurality of candidate addresses; and a second processing module, coupled to the first processing module and the address generating module, within the candidate number array sent from the first processing module, the second processing module selecting the candidate number(s) corresponding to the specific address as random number(s).

### BACKGROUND OF THE INVENTION

1. Field of the Invention

The present invention relates to data processing, and more particularly, to random number generators and random number generating methods.

2. Description of the Prior Art

How to generate random numbers has long been an issue for computers and/or related electronic applications. When simulating some unpredictable or irregular phenomena such as noises, random numbers may be utilized for generating data representing these phenomena. Generally speaking, a basic requirement for a random number generator or a random number generating function is that the random number generated each time is untraceable, which means there is no rule that can be utilized for tracing random numbers generated by the random number generator or the random number generating function, so as to comply with the unpredictable or irregular phenomena.

Typically, an initial value of the random numbers generated by the random number generator or the random number generating function mentioned above can be determined by assigning a seed of a random number sequence in order to comply with a specific requirement; for example, utilizing two random number sequences that are substantially the same to verify correctness of some operational equations. Please note that two random number sequences generated by utilizing the same seed are equivalent to each other, no matter when they are respectively generated. Conversely, by utilizing different seeds, different random number sequences can be generated.

Although different random number sequences can be generated by utilizing different seeds according to conventional random number generating methods, problems such as periodic appearance of random numbers within a random number sequence (e.g. one of the random number sequences that are different from each other) may easily occur, causing side effects on certain data processing operations and therefore influencing performance of these data processing operations.

### SUMMARY OF THE INVENTION

It is an objective of the claimed invention to provide random number generators and random number generating methods to solve the above-mentioned problem.

According to one embodiment of the claimed invention, a random number generator is disclosed. The random number generator comprises: a first processing module, for generating at least one candidate number array comprising a plurality of candidate numbers respectively corresponding to a plurality of candidate addresses; an address generating module, for generating at least one specific address according to at least one generator polynomial, where each specific address is a candidate address within the plurality of candidate addresses; and a second processing module, coupled to the first processing module and the address generating module, within the candidate number array sent from the first processing module, the second processing module selecting the candidate number(s) corresponding to the specific address as random number(s).

According to one embodiment of the claimed invention, a random number generating method is disclosed. The random number generating method comprises: generating at least one candidate number array comprising a plurality of candidate numbers respectively corresponding to a plurality of candidate addresses; generating at least one specific address according to at least one generator polynomial, where each specific address is a candidate address within the plurality of candidate addresses; and within the candidate number array sent from the first processing module, selecting the candidate number(s) corresponding to the specific address as random number(s).

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a random number generator according to one embodiment of the present invention.

FIG. 2 is a diagram of processing modules provided in a random number generating method according to one embodiment of the present invention.

FIG. 3 illustrates a variation of the embodiment shown in FIG. 2.

### DETAILED DESCRIPTION

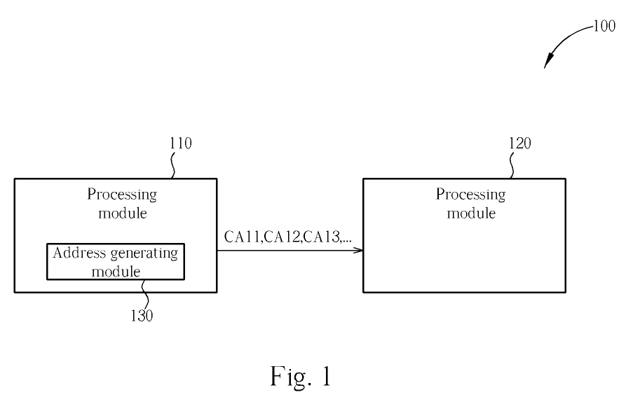

Please refer to FIG. 1. FIG. 1 is a diagram of a random number generator 100 according to one embodiment of the present invention. The random number generator 100 comprises two processing modules 110 and 120 and an address generating module 130, where the address generating module 130 of this embodiment is embedded in the processing module 110, the processing module 110 is a host processing module, and the processing module 120 is a slave processing module.

According to this embodiment, the processing module 110 is capable of generating at least one candidate number array CA comprising a plurality of candidate numbers respectively corresponding to a plurality of candidate addresses Add-1, Add-2, . . . , and Add-N (not shown), where a candidate number can be selected by assigning a candidate address. As shown in FIG. 1, the processing module 110 of this embodiment generates a plurality of candidate number arrays CA11, CA12, CA13, . . . , etc., each of which comprises a plurality of candidate numbers respectively corresponding to the plurality of candidate addresses Add-1, Add-2, . . . , and Add-N mentioned above. In addition, when generating these candidate number arrays CA11, CA12, CA13, . . . , etc., the processing module 110 rearranges the candidate numbers within these candidate number arrays.

According to this embodiment, the address generating module 130 is capable of generating at least one specific address according to at least one generator polynomial, and each specific address is a candidate address within the plurality of candidate addresses Add-1, Add-2, . . . , and Add-N. In this embodiment, the address generating module 130 generates M specific addresses Add-I(1), Add-I(2), . . . , and Add-I(M) according to a plurality of generator polynomials, and more particularly, generates the M specific addresses according to coefficients of the plurality of generator polynomials, where the coefficients of the generator polynomials can be utilized as a plurality of bits of data for generating indexes representing specific addresses. The number M mentioned above is a positive integer greater than one, and I(m) (where m=1, 2, . . . , M) represents a number out of 1, 2, . . . , and N. That is, each of these specific addresses Add-I(l), Add-I(2), . . . , and Add-I(M) is a candidate address within the candidate addresses Add-1, Add-2, . . . , and Add-N.

Within the candidate number arrays CA11, CA12, CA13, . . . , etc. sequentially sent from the processing module 110, the processing module 120 is capable of selecting candidate numbers corresponding to the M specific addresses Add-I(1), Add-I(2), . . . , and Add-I(M) as random numbers, where the operations mentioned above can be explained in detail as follows.

Within the first candidate number array CA11 sent from the processing module 110, the processing module 120 first selects a candidate number corresponding to the specific address Add-I(1) as a random number. The first candidate number array CA11 can be utilized a plurality of times, for example, K1 times, and within the first candidate number array CA11, the processing module 120 sequentially selects the candidate numbers corresponding to the specific addresses Add-I(1), Add-I(2), . . . , and Add-I(K1) as random numbers. Then, one of the processing modules 110 and 120 determines to change the candidate number array that is utilized currently, where the processing module for determining changing the candidate number array that is utilized currently is the host processing module in this embodiment, i.e. the processing module 110. As a result, within the candidate number array CA12, the processing module 120 sequentially selects the candidate numbers corresponding to the specific addresses Add-I(K1+1), Add-I(K1+2), . . . , and Add-I(K1+K2) as random numbers. Afterwards, within the candidate number array CA13, the processing module 120 sequentially selects the candidate numbers corresponding to the specific addresses Add-I(K1+K2+1), Add-I(K1+K2+2), . . . , and Add-I(K1+K2+K3) as random numbers. According to an implementation choice of this embodiment, the operations mentioned above can be continued till the candidate number corresponding to the specific address Add-I(M) is selected as a random number. The operations mentioned above can also be continued by overriding the latest random number array from the processing module 110 to the processing module 120, in order to generate new random numbers according to the latest specific addresses continuously. Please note that specific addresses of different cyclic periods can be generated according to different generator polynomials, so by the operations mentioned above, the present invention is capable of eliminating the prior art problems such as periodic appearance of random numbers within a random number sequence. According to this embodiment, the processing module 120 is a digital image halftone processing module for correcting patterns due to quantization errors according to the generated random numbers.

According to a variation of this embodiment, the processing module 120 is a communication processing module for performing encryption/decryption processing according to the generated random numbers, where the override mechanism mentioned above makes the encrypted communication content hard to be decrypted. According to another variation of this embodiment, the processing modules 110 and 120 can be respectively installed in a host personal computer (PC) and a slave PC, where the processing module 110 is a communication processing module for generating random numbers according to the generated random number array to perform encryption processing, and the processing module 120 is a communication processing module for generating random numbers according to the latest random number array sent from the processing module 110 to perform decryption processing.

According to another variation of this embodiment, values of the numbers K1, K2, K3, . . . , etc. are determined according to a common predetermined value, where the values of the numbers K1, K2, K3, . . . , etc. are equal to each other. According to another variation of this embodiment, values of the numbers K1, K2, . . . , etc. can be randomly defined, where the operations of randomly defining the values of the numbers K1, K2, . . . , etc. can be utilized for eliminating the prior art problems such as periodic appearance of random numbers within a random number sequence.

According to another embodiment of the present invention, which is also a variation of this embodiment mentioned above, the mechanism that determines whether to change the candidate number array that is utilized currently, for example, the processing module 110 or the processing module 120, determines whether to override the latest random number array from the processing module 110 to the processing module 120 according to a function of time. According to a variation of this embodiment, the latest random number array is periodically overridden from the processing module 110 to the processing module 120. According to another variation of this embodiment, the latest random number array is randomly overridden from the processing module 110 to the processing module 120, where the operations of randomly overriding the latest random number array can be utilized for eliminating the prior art problems such as periodic appearance of random numbers within a random number sequence.

According to a variation of the embodiment shown in FIG. 1, the address generating module 130 can be embedded in the processing module 120, rather than being embedded within the processing module 110. In this situation, the processing module 120 is a host processing module and the processing module 110 is a slave processing module.

According to another variation of the embodiment shown in FIG. 1, the address generating module 130 is positioned outside the processing modules 110 and 120, rather than being embedded within the processing module 110 or the processing module 120.

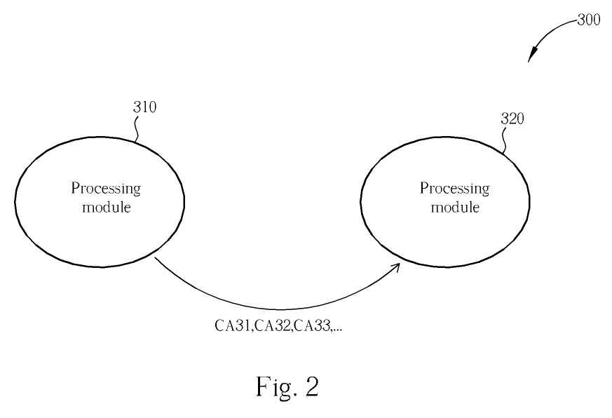

Please refer to FIG. 2. FIG. 2 is a diagram of the processing modules 310 and 320 provided in a random number generating method according to one embodiment of the present invention. This embodiment is a variation of the embodiment shown in FIG. 1, where the processing modules 310 and 320 can be utilized for respectively representing two modules within a program code 300 (for example, two procedures; in another example, two objects within an object-oriented program), operations of the processing modules 310 and 320 respectively correspond to those of the processing modules 110 and 120 mentioned above, and a plurality of candidate number arrays CA31, CA32, CA33, . . . , etc. of this embodiment respectively correspond to the plurality of candidate number arrays CA11, CA12, CA13, . . . , etc. mentioned above. That is, the random number generating method disclosed in the embodiment shown in FIG. 1 not only can be implemented by utilizing hardware devices (for example, the modules 110, 120, and 130 within the random number generator 100), but also can be implemented by utilizing software (for example, the two software modules within the program code 300, i.e. the processing modules 310 and 320).

According to an implementation choice of this embodiment, if the random number generating method mentioned above is implemented by utilizing software, operations corresponding to the address generating module 130 can be integrated into one of the processing modules 310 and 320. For example, the operations corresponding to the address generating module 130 are integrated into the processing module 310 in this embodiment. Similar descriptions are not repeated in detail.

According to a variation of this embodiment, the processing modules 310 and 320 can be software modules of different program codes, respectively. For example, the processing module 310 can be a procedure installed within an operating system (OS), and the processing module 320 can be an operation module installed within an application program.

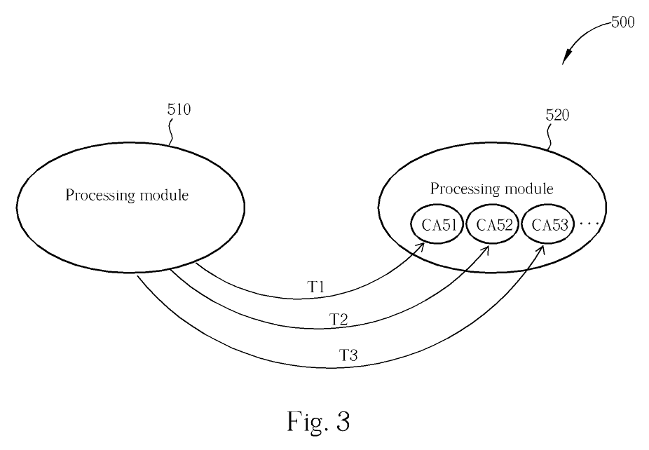

FIG. 3 illustrates a variation of the embodiment shown in FIG. 2, where the processing modules 510 and 520 can be utilized for respectively representing two modules within a program code 500 (for example, two procedures; in another example, two objects within an object-oriented program), operations of the processing modules 510 and 520 respectively correspond to those of the processing modules 310 and 320 mentioned above, and a plurality of candidate number arrays CA51, CA52, CA53, . . . , etc. of this embodiment respectively correspond to the plurality of candidate number arrays CA31, CA32, CA33, . . . , etc. mentioned above. The candidate number arrays CA51, CA52, CA53, . . . , etc. of this embodiment are respectively sent from the processing module 510 to the processing module 520 at time points T1, T2, T3, . . . , etc., as shown in FIG. 3. Similar descriptions are not repeated in detail.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A random number generator, comprising:
a first processing module, for generating at least one candidate number array comprising a plurality of candidate numbers respectively corresponding to a plurality of candidate addresses;
an address generating module, for generating at least one specific address according to at least one generator polynomial, wherein each specific address is a candidate address within the plurality of candidate addresses; and
a second processing module, coupled to the first processing module and the address generating module, within the at least one candidate number array sent from the first processing module, the second processing module selecting the candidate number(s) corresponding to the at least one specific address as random number(s).

2. The random number generator of claim 1, wherein the address generating module is embedded in the first processing module, the first processing module is a host processing module, and the second processing module is a slave processing module.

3. The random number generator of claim 1, wherein the address generating module is embedded in the second processing module, the second processing module is a host processing module, and the first processing module is a slave processing module.

4. The random number generator of claim 1, wherein the first processing module generates a plurality of candidate number arrays, each of which comprises a plurality of candidate numbers respectively corresponding to the plurality of candidate addresses; and within the latest candidate number array sent from the first processing module, the second processing module is capable of selecting the candidate number(s) corresponding to the at least one specific address as random number(s).

5. The random number generator of claim 1, wherein the address generating module generates a plurality of specific addresses according to the at least one generator polynomial, and each of the plurality of specific addresses is a candidate address within the plurality of candidate addresses; and within the at least one candidate number array sent from the first processing module, the second processing module is capable of selecting the candidate numbers corresponding to the plurality of specific addresses as random numbers.

6. The random number generator of claim 5, wherein the address generating module generates the plurality of specific addresses according to a plurality of generator polynomials.

7. The random number generator of claim 1, wherein when generating the at least one candidate number array, the first processing module rearranges the candidate numbers within the at least one candidate number array.

8. The random number generator of claim 1, wherein the second processing module is a digital image halftone processing module for correcting patterns due to quantization errors according to the generated random numbers.

9. The random number generator of claim 1, wherein at least one processing module of the first processing module and the second processing module is a communication processing module for performing encryption/decryption processing according to the generated random numbers.

10. The random number generator of claim 1, wherein the first processing module is a communication processing module for generating random numbers according to the generated random number array to perform encryption processing, and the second processing module is a communication processing module for generating random numbers according to the latest random number array sent from the first processing module to perform decryption processing.

11. A random number generating method, comprising:
generating at least one candidate number array comprising a plurality of candidate numbers respectively corresponding to a plurality of candidate addresses;
generating at least one specific address according to at least one generator polynomial, wherein each specific address is a candidate address within the plurality of candidate addresses; and
within the at least one candidate number array sent from the first processing module, selecting the candidate number(s) corresponding to the at least one specific address as random number(s).

12. The random number generating method of claim 11, further comprising:
providing a first processing module and a second processing module, wherein the first processing module and the second processing module are capable of being hardware devices or software modules;
utilizing the first processing module to generate the at least one candidate number array;
utilizing the first processing module or the second processing module to generate the at least one specific address according to the at least one generator polynomial; and
within the at least one candidate number array sent from the first processing module, utilizing the second processing module to select the candidate number(s) corresponding to the at least one specific address as random number(s).

13. The random number generating method of claim 12, wherein the second processing module is a digital image halftone processing module for correcting patterns due to quantization errors according to the generated random numbers.

14. The random number generating method of claim 12, wherein at least one processing module of the first processing module and the second processing module is a communication processing module for performing encryption/decryption processing according to the generated random numbers.

15. The random number generating method of claim 12, wherein the first processing module is a communication processing module for generating random numbers according to the generated random number array to perform encryption processing, and the second processing module is a communication processing module for generating random numbers according to the latest random number array sent from the first processing module to perform decryption processing.

16. The random number generating method of claim 11, wherein if the first processing module generates the at least one specific address, the first processing module is a host processing module and the second processing module is a slave processing module; otherwise, the second processing module is a host processing module and the first processing module is a slave processing module.

17. The random number generating method of claim 11, wherein the step of generating at least one candidate number array further comprises:
generating at least one candidate number array, each of which comprises a plurality of candidate numbers respectively corresponding to the plurality of candidate addresses;
wherein the step of selecting the candidate number(s) corresponding to the at least one specific address further comprises:
within the latest candidate number array, selecting the candidate number(s) corresponding to the at least one specific address as random number(s).

18. The random number generating method of claim 11, wherein the step of generating at least one specific address further comprises:
generating a plurality of specific addresses according to at least one generator polynomial, each of the plurality of specific addresses being a candidate address within the plurality of candidate addresses;
wherein the step of selecting the candidate number(s) corresponding to the at least one specific address further comprises:
within the at least one candidate number array, selecting the candidate numbers corresponding to the plurality of specific addresses as random numbers.

19. The random number generating method of claim 17, wherein the step of generating at least one specific address further comprises:
generating the plurality of specific addresses according to a plurality of generator polynomials.

20. The random number generating method of claim 11, wherein the step of generating at least one candidate number array further comprises:
rearranging the candidate numbers within the at least one candidate number array.
